(19) United States
(12) Patent Application Publication
(10) Pub. No.: US 2026/0056676 A1
(43) Pub. Date: Feb. 26, 2026

(54) SMART NIC RESPONDING TO REQUESTS FROM CLIENT DEVICE

(71) Applicant: VMware LLC, Palo Alto, CA (US)

(72) Inventors: Alex Markuze, Rosh HaAyin (IL); Shay Vargaftik, Herzliya (IL); Igor Golikov, Kfar Saba (IL); Yaniv Ben-Itzhak, Afek (IL); Avishay Yanai, Petach-Tikva (IL)

(21) Appl. No.: 19/371,073

(22) Filed: Oct. 28, 2025

Related U.S. Application Data
(63) Continuation of application No. 17/845,766, filed on Jun. 21, 2022, now Pat. No. 12,481,444.

(51) Int. Cl. G06F 3/06

(52) U.S. Cl. CPC G06F 3/0647; G06F 3/0604; G06F 3/067

(57) ABSTRACT

Some embodiments provide a method for transmitting data at a network interface controller (NIC) of a computer that operates as a server. The computer includes multiple storage devices. The method receives a request from a client device for a particular file. The method translates the particular file into a memory location corresponding to a particular one of the storage devices at the computer. The method transmits the requested file from the particular storage location to the client device.

### CLAIM OF BENEFIT TO PRIOR APPLICATION

The present application is a continuation application of U.S. application Ser. No. 17/845,766, filed Jun. 21, 2022, and published on Dec. 21, 2023, under Publication No. 2023-0409225. This application is incorporated herein by reference in its entirety for all purposes.

### BACKGROUND

Especially in the datacenter context, programmable smart network interface controllers (NICs) are becoming more commonplace. These smart NICs typically include a central processing unit (CPU), possibly in addition to one or more application-specific integrated circuits (ASICs) or field-programmable gate arrays (FPGAs). These ASICs (or FPGAs) can be designed for packet processing as well as other uses. However, the inclusion of the CPU also allows for more configurability of the smart NICs, thereby enabling the offloading of some tasks from software of a host computer.

### BRIEF SUMMARY

Some embodiments provide a network interface controller (NIC) that translates file identifiers in client requests into local memory locations in order to transmit files to client devices in response to the client requests. The NIC, in some embodiments, is a smart NIC that includes at least a configurable processor for more than simply performing basic I/O data message handling. The NIC is configured to translate an identifier in a client request (e.g., a file name or other virtual identifier) into a memory location of a specific storage device. The NIC then reads the data for the file from the memory location and transmits the requested file data from the memory location to the client device.

The NIC, in some embodiments, is the network interface for a computer that operates as a server, having one or more storage devices that store files which can be requested by clients. In some embodiments, the storage devices can include a set of one or more non-volatile memory express (NVMe) storage devices connected to the NIC. In some embodiments, the NIC accesses these NVMe devices directly, without communicating with the CPU of the computer. The storage devices may also include memory or a hard disk associated with the CPU as well as memory of the NIC itself, in some embodiments. In other embodiments, the computer does not actually include a full-scale CPU (i.e., an x86 or ARM CPU), but instead only includes a processor that can boot up the system, the NIC configured to perform file identifier translation, and a set of NVMe devices storing the files. In other embodiments, the computer includes a CPU that executes a network stack to manage connections (e.g., TCP connections) with clients.

In some embodiments, a client device sends a request as a data message that stores the identifier for the file and, in some cases, an offset that indicates a specific portion of the particular file (e.g., a timestamp for media content). Upon receipt of the request, the NIC maps the file identifier to one of its connected storage devices and a memory location within that storage device. In addition, the NIC uses the offset (if present) to identify a memory location for the requested starting point in the file. The NIC can read the data from this starting point and transmit the data to the client device. Typically, the transmission of the data requires numerous data messages, depending on the amount of data to be transmitted.

The computer, as mentioned, operates as a server in some embodiments. For instance, the computer is one of numerous computers operating within a datacenter to provide data in response to client requests for a service (e.g., providing media content to customers of a streaming service). Each of the computers (or at least a subset of the computers) includes its own set of storage devices, which store data files provided by the service. Each file can be stored on multiple computers, with the NIC of each computer having its own translation table (i.e., so that the files need not be organized in exactly the same manner on each computer's storage devices). When a request is received at the datacenter, a load balancer (e.g., a separate NIC operating at a load balancer computer) uses the file identifier in the request to forward the data message to one of the computers that stores the requested file. The NIC at the computer that receives the request can then service the request and provide the requested file data.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates the hardware of a smart NIC of some embodiments that can be configured to translate file identifiers into memory addresses for a particular device in order to service client requests.

FIG. 2 conceptually illustrates the NIC operating system of a smart NIC of some embodiments.

FIG. 3 conceptually illustrates a server system with a lightweight NIC connected to a boot-up processor and a set of NVMe devices.

FIG. 4 conceptually illustrates a process of some embodiments for responding to client requests for file data by translating a file identifier in a client request into a memory location of a specific device.

FIG. 5 conceptually illustrates the use of a translation table by a NIC of some embodiments.

FIG. 6 conceptually illustrates a datacenter with multiple file servers.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a network interface controller (NIC) that translates file identifiers in client requests into local memory locations in order to transmit files to client devices in response to the client requests. The NIC, in some embodiments, is a smart NIC that includes at least a configurable processor for more than simply performing basic I/O data message handling. The NIC is configured to translate an identifier in a client request (e.g., a file name or other virtual identifier) into a memory location of a specific storage device. The NIC then reads the data for the file from the memory location and transmits the requested file data from the memory location to the client device.

The NIC, in some embodiments, is the network interface for a computer that operates as a server, having one or more storage devices that store files which can be requested by clients. In some embodiments, the storage devices can include a set of one or more non-volatile memory express (NVMe) storage devices connected to the NIC. In some embodiments, the NIC accesses these NVMe devices directly, without communicating with the CPU of the computer. The storage devices may also include memory or a hard disk associated with the CPU as well as memory of the NIC itself, in some embodiments. In other embodiments, the computer does not actually include a full-scale CPU (i.e., an x86 or ARM CPU), but instead only includes a processor that can boot up the system, the NIC configured to perform file identifier translation, and a set of NVMe devices storing the files. In other embodiments, the computer includes a CPU that executes a network stack to manage connections (e.g., TCP connections) with clients.

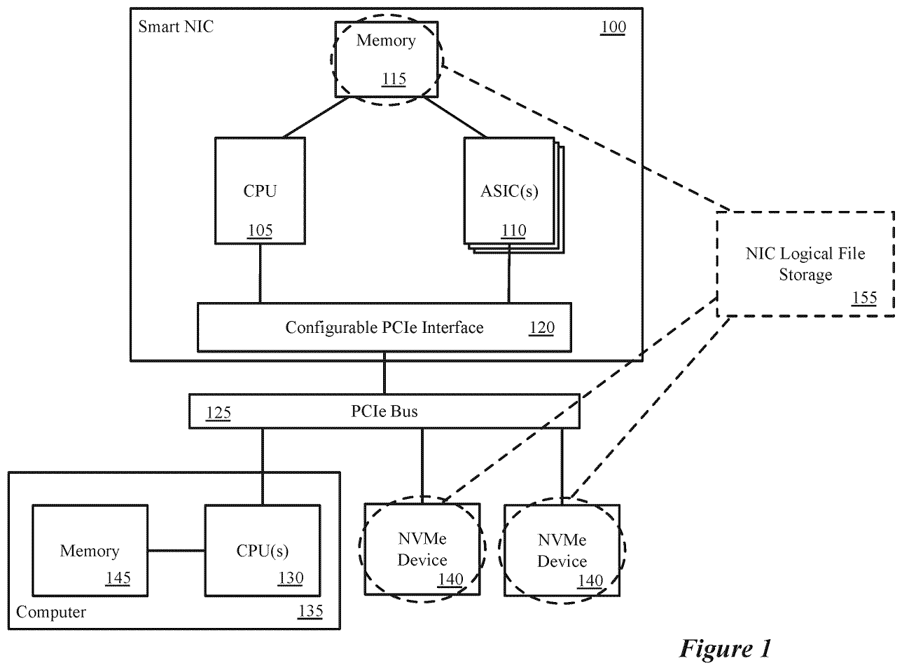

FIG. 1 conceptually illustrates the hardware of a smart NIC 100 of some embodiments that can be configured to translate file identifiers into memory addresses for a particular device in order to service client requests. As shown, the smart NIC 100 includes its own general-purpose (e.g., x86 or ARM) CPU 105, a set of application-specific integrated circuit (ASICs) 110, memory 115, and a configurable PCIe interface 120. The ASICs 110, in some embodiments, include at least one I/O ASIC that handles the processing of data messages forwarded to and from the computer (e.g., performing forwarding according to a set of forwarding entries). In some embodiments, these ASICs 110 are at least partly controlled by the CPU 105. In some embodiments, either in addition to or as an alternative to the ASICs, the smart NIC may include a set of configurable field-programmable gate arrays (FPGAs). It should be noted that, in some embodiments, the CPU is a lightweight processor (e.g., not an ARM or x86 processor) that only functions to perform file identifier to memory address translation. In other embodiments, the NIC 100 does not include a general-purpose processor at all and instead an ASIC or FPGA is configured to perform the file identifier to memory address translation.

The configurable PCIe interface 120 enables connection of the smart NIC 100 to the other physical components of a computer system via a PCIe bus 125 of the computer system. Via this configurable PCIe interface 120, the smart NIC 100 can present itself to the computer system as a multitude of devices, including a data message processing NIC, a hard disk (using non-volatile memory express (NVMe) over PCIe), or other types of devices. As shown, also connected to the PCIe bus 125 is (i) a set of CPU(s) 130 of a host computer 135 and a set of NVMe devices 140. In this case, the computer includes two NVMe devices 140, but it should be understood that any number of such storage devices (including other types of storage devices) are possible for storing data to service client requests.

The host computer 135 includes at least a set of CPUs 130 (e.g., a single processor, a multi-core processor, etc.) and a memory (e.g., one or more random access memories) 145. In different embodiments, the host computer 135 may be a bare metal (i.e., non-virtualized) computing device or may operate a set of virtualized data compute nodes (e.g., containers, virtual machines, etc.). The host computer CPU 130 of some embodiments executes a network stack in some embodiments as well as various other processes (e.g., operating system, hypervisor, applications, etc.), making use of the memory 145. In some embodiments, the host computer network stack manages connections (e.g., TCP connections) with clients that request data (while the smart NIC 100 manages the actual data transfer to the clients).

The NVMe devices 140 connect to the host computer 135 as well as the smart NIC 100 via the PCIe bus 125. The NVMe devices 140 can be used as storage (e.g., disk storage) for the system. For instance, in some embodiments the NVMe devices 140 store files that the smart NIC 100 uses to service client requests. In some embodiments, the NIC 100 is configured to access data spanning its own memory 115 as well as the NVMe devices 140 (and in some cases also the memory 145 of the computer 135). These different storages are combined to form a NIC logical file storage 155, with the NIC able to translate file identifiers from client requests into physical or virtual memory locations in these various storage components. In some embodiments, the logical file storage 155 can include additional physical (or virtual) memory devices (e.g., other types of disk storage). In some embodiments, the NIC logical file storage 155 may even include devices accessible via a network (e.g., NVMe devices accessible via NVMe over fabric protocols).

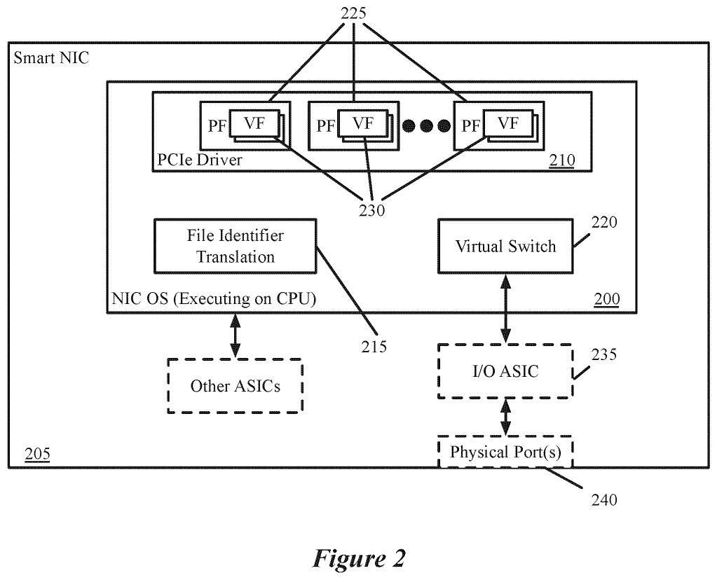

In some embodiments, the CPU 105 of the smart NIC 100 executes a NIC operating system (OS) that controls the ASICs 110 and can perform other operations as well, including file identifier to memory address translation. FIG. 2 conceptually illustrates the NIC OS 200 of a smart NIC 205 of some embodiments. The NIC OS 200 is executed, in some embodiments, by the CPU of the smart NIC (e.g., CPU 105). This NIC OS 200 includes a PCIe driver 210, a virtual switch 220, and other functions 215.

The PCIe driver 210 includes multiple physical functions 225, each of which is capable of instantiating multiple virtual functions 230. These different physical functions 225 enable the smart NIC 205 to present as multiple different types of devices to the computer system to which it attaches via its PCIe bus. For instance, the smart NIC 205 can present itself as a network adapter (for processing data messages to and from the computer system) as well as an NVMe disk in some embodiments.

The NIC OS 200 of some embodiments is capable of executing a virtualization program (similar to a hypervisor) that enables sharing resources (e.g., memory, CPU resources) of the smart NIC 205 among multiple machines (e.g., VMs) if those VMs execute on the computer. The virtualization program can provide compute virtualization services and/or network virtualization services similar to a managed hypervisor in some embodiments. These network virtualization services, in some embodiments, include segregating data messages into different private (e.g., overlay) networks that are defined over the physical network (shared between the private networks), forwarding the data messages for these private networks (e.g., performing switching and/or routing operations), and/or performing middlebox services for the private networks.

To implement these network virtualization services, the NIC OS 200 of some embodiments executes the virtual switch 220. The virtual switch 220 enables the smart NIC 205 to perform software-defined networking and provide the I/O ASIC 235 of the smart NIC 205 with a set of flow entries (e.g., the cache entries described herein) so that the I/O ASIC 235 can perform flow processing offload (FPO) for the computer system in some embodiments. The I/O ASIC 235, in some embodiments, receives data messages from the network and transmits data messages to the network via one or more physical network ports 240.

The file identifier translation function 215 executed by the NIC operating system 200 of some embodiments translates between file identifiers (e.g., in client request messages) and physical or virtual memory addresses of multiple devices, including the physical NIC memory and any number of NVMe devices. The NIC OS 200 can also include various other operations, including operations not directly related to data message processing (e.g., operations for a machine-learning system).

In other embodiments, as indicated above, the NIC does not run a full NIC OS. Instead, either a lightweight CPU (e.g., a non-x86/ARM processor) or an ASIC or FPGA is configured to perform the logical memory address translation. In this case, the NIC is also capable of performing typical I/O data message processing functions. In addition, some embodiments do not require a full-scale computer with an x86 or ARM CPU. Rather, some such embodiments essentially include a NIC configured to perform file identifier translation as well as a set of NVMe devices that store files for client requests.

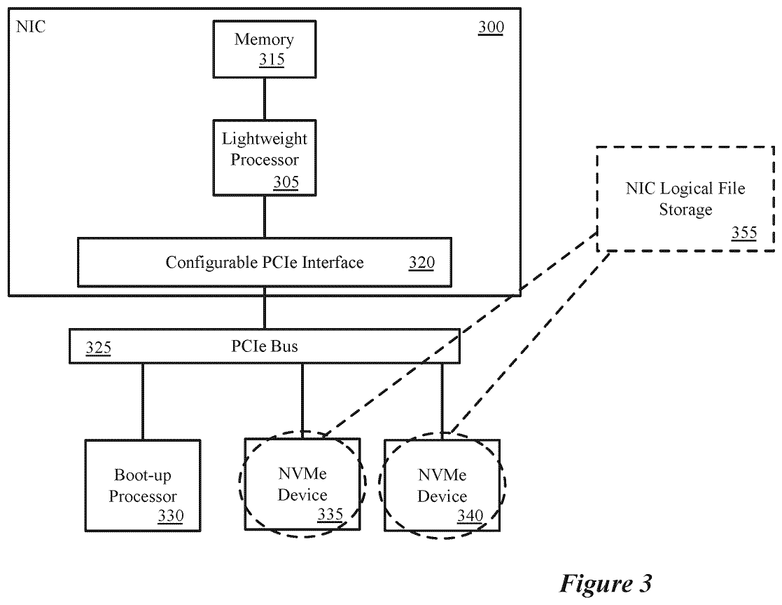

FIG. 3 conceptually illustrates such a server system with a NIC 300 connected to a processor 330 and a set of NVMe devices 335 and 340. In this example, the NIC 300 includes a lightweight processor 305, a memory 315, and a configurable PCIe interface 320. The lightweight processor 305 can be a lightweight CPU, an ASIC, or an FPGA that is configured to service client requests by translating file identifiers in client request data messages into memory addresses of specific connected devices, read file data from the memory addresses, and transmit data messages to the requesting clients. In some embodiments, the NIC 300 also includes an I/O processor (e.g., an ASIC or FPGA) for handling the data message receipt and transmission. This may be a separate processor or a function also performed by the lightweight processor 305.

The memory 315, in some embodiments, stores a file identifier translation table used by the lightweight processor 305 to translate file identifiers into memory addresses, as further described below. As described above, the configurable PCIe interface 320 enables connection of the NIC 300 to the other physical components of a computer system via a PCIe bus 325 of the computer system. In this example, all of the file storage is in the two NVMe devices 335 and 340, which form a logical file storage 355 for the NIC 300 as described above by reference to FIG. 1.

The boot-up processor 330 is also a lightweight processor that does not perform any functions (or only performs minimal functions) once the system is running. Instead, the boot-up processor 330 is primarily responsible for booting up the computer system so that the NIC 300 can perform file identifier translation and transmit file data from the NVMe devices 335 and 340.

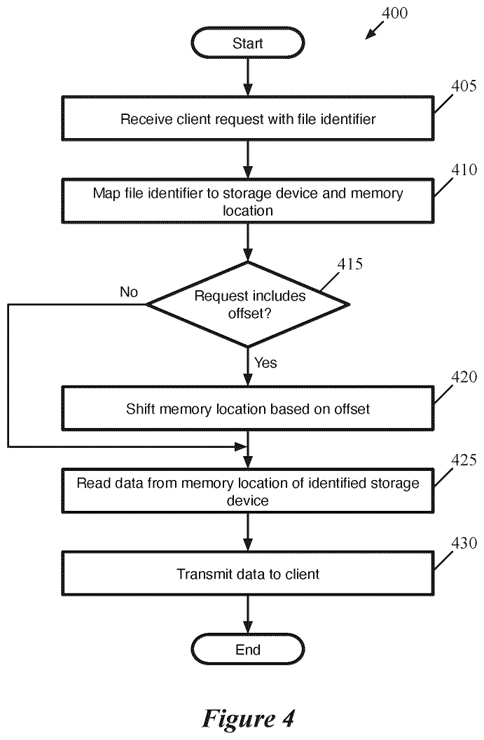

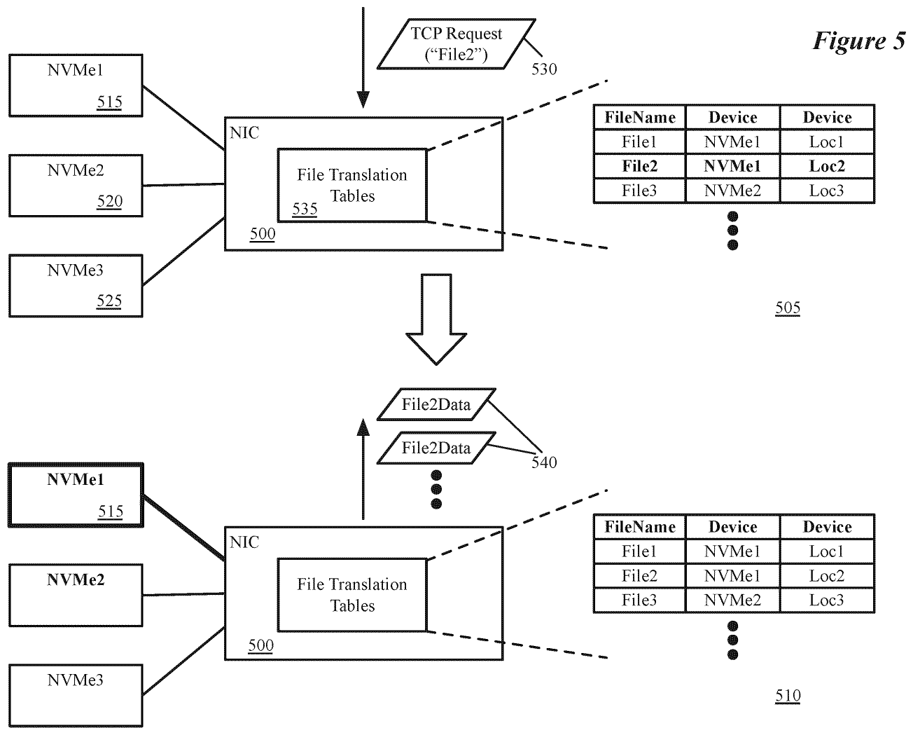

FIG. 4 conceptually illustrates a process 400 of some embodiments for responding to client requests for file data by translating a file identifier in a client request into a memory location of a specific device. The process 400 is performed, in some embodiments, by a NIC such as that shown in FIG. 1 or FIG. 3. The process 400 will be described in part by reference to FIG. 5, which conceptually illustrates the use of a translation table by the NIC of some embodiments over two stages 505-510.

As shown, the process 400 begins by receiving (at 405) a client request that includes a file identifier. In some embodiments, a client device initiates a connection with the server (or with a front-end load balancer for a set of file servers in a datacenter) in order to send the request. The request itself is a TCP segment or similar format data message that includes the file identifier and, in some cases, an offset that indicates a specific portion of the particular file. For instance, in some embodiments the server is part of a streaming service (e.g., for streaming audio and/or video content to subscribers) and the request includes both a file identifier (specifying a particular piece of media content) and a timestamp (specifying a start time in the media content). In some embodiments, the NIC also extracts this file identifier (and any offset) from the received request.

The process 400 then maps (at 410) the file identifier to a storage device and memory location. As indicated, the server of some embodiments includes a NIC with multiple connected storage devices (e.g., multiple NVMe devices). The NIC uses a set of translation tables to map the file identifier to the device and location. In the first stage 505 of FIG. 5, a NIC 500 with three connected NVMe devices 515-525 receives a request 530. This request 530 is received as a TCP message that includes the file identifier “File2”. The NIC 500 stores translation tables 535, which it uses to translate the file identifier received in the request 530 into a storage device and memory location.

The file translation tables 535 map file identifiers for files stored on the NVMe devices 515-525 to device identifiers as well as memory locations (i.e., memory addresses) on that device. Thus, the file identifier “File1” maps to a first location “Loc1” on the first storage device 515, the file identifier “File2” maps to a second location “Loc2” on that same storage device 515, the file identifier “File3” maps to a location “Loc3” on the second storage device 520, and so on for each file stored at this computer. As shown using bold text, the NIC 500 uses these translation tables 535 to map the received identifier “File2” to location “Loc2” on the first storage device 515.

Returning to FIG. 4, the process 400 determines (at 415) whether the received request includes an offset. If the entire file is requested, then the client may not send an offset with the request. Similarly, if the server belongs to a media streaming service, then if a client is viewing or listening to the content from the beginning, no offset may be sent with the request. However, if the client is, e.g., viewing a television episode or movie starting at a middle point of the content then this time offset may be included within the request.

When an offset is included, the process 400 shifts (at 420) the identified memory location based on this offset. If the offset is a timestamp in media content and the media content requires a known amount of storage per unit of time, the amount to shift based on the timestamp can be calculated. Other embodiments store additional information with the translation tables, such as memory locations for various timestamps within each piece of media content. For other types of content, the amount of memory to shift by may be calculated based on other information (e.g., using stored information indicating the total size of the requested file).

With the memory location from which to start determined (i.e., using either the starting memory location for the requested file or a shifted memory location based on a client-specified offset), the process 400 reads (at 425) data from this memory location of the identified storage device. If the memory location refers to a location within an NVMe device (or a similar storage connected via the PCIe bus), the NIC reads this information directly from the device (via its PCIe interface) without the involvement of the CPU.

Finally, the process 400 transmits (at 430) the data to the client, then ends. In some embodiments, the NIC sends numerous data messages in order to transmit the entire file to the client. In the case of streaming media content, the transmission of data may take place over a lengthy period of time. This data, in some embodiments, is transmitted as a set of TCP segments via the established network connection through which the client request was received. The second stage 510 of FIG. 5 shows that the NIC 500 reads data from the first storage device 515 (shown by the bolded lines) and transmits this data as a set of data messages 540.

As described, the computer operates as a server in some embodiments to provide data in response to client requests. In some embodiments, numerous such computers are located in a datacenter to all store data and provide that data to clients. For instance, a streaming service may have multiple such datacenters (e.g., in different geographic locations) to stream media content to subscribers. Within such a datacenter, each of the computers that operates as a server to provide data to clients includes its own set of connected storage devices (e.g., NVMe devices). In some such embodiments, each file (e.g., each piece of media content) may be stored on multiple computers (e.g., with content that is expected to be more popular stored on more of the computers).

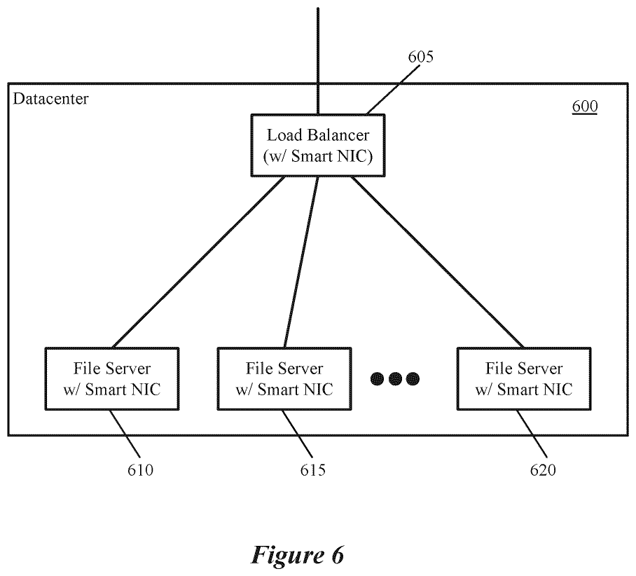

FIG. 6 conceptually illustrates an example of such a datacenter 600 with multiple file servers 610-620. Each of these file servers 610-620 includes a smart NIC and a set of storage devices, such as is shown in FIG. 1 or FIG. 3. Some embodiments store the same set of files on each of the file servers 610-620. Other embodiments, however, store different sets of files on each file server 610-620. In the latter case, some files may be stored on only a single server while other files are stored on multiple servers. In either case, the NIC for each of the file servers 610-620 stores its own translation table based on the arrangement of files in its local storage. Thus, even if two file servers store the same set of files, they do not need to store them in the same manner because the translation tables can be different.

When a client request is received at the datacenter 600, a load balancer 605 analyzes the file identifier in the client request to determine to which of the file servers 610-620 the request should be forwarded. If a requested file is located at more than one of the file servers 610-620, the load balancer 605 uses any of a number of different load balancing techniques to select one of these file servers and forward the request to the selected file server. In different embodiments, the load balancer 605 may use round-robin load balancing, an algorithm that accounts for the current load on the different servers (measured in number of active connections, amount of data transferred, etc.), a hash-based distribution, an algorithm that accounts for the capabilities of the different servers, a combination thereof, etc. In some embodiments, for faster processing, a smart NIC located at the load balancer maps the file identifier in a request to a set of servers at which the file is located and/or performs the load balancing to select one of these servers. Once the load balancer 605 forwards the client request to a selected file server, that file server services the request and provides the requested file data as described above.

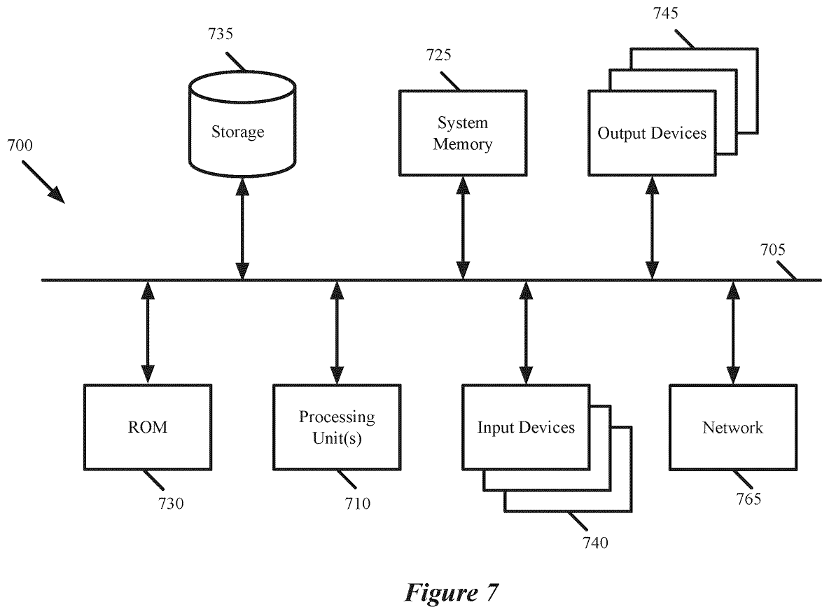

FIG. 7 conceptually illustrates an electronic system 700 with which some embodiments of the invention are implemented. The electronic system 700 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments.

The read-only-memory (ROM) 730 stores static data and instructions that are needed by the processing unit(s) 710 and other modules of the electronic system. The permanent storage device 735, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory is a volatile read-and-write memory, such a random-access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the electronic system. The input devices 740 include alphanumeric keyboards and pointing devices (also called “cursor control devices”). The output devices 745 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples electronic system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 4) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A device comprising:
an interface coupled to a bus;
a processor configured to receive a request from a client device for a file, the request comprising a file identifier; and
a memory storing a translation table, the translation table configured to map the file identifier to a memory location corresponding to a storage device coupled to the bus;
wherein the processor is configured to:
extract the file identifier from the request,
map the file identifier to the storage device and memory location using the translation table,
determine an offset in the request indicating a portion of the file,
modify the memory location based on the offset, and
read data from the memory location of the storage device via the interface.

2. The device of claim 1, wherein the processor is configured to transmit the data to the client device, and transmitting the data comprises sending data messages to the client device.

3. The device of claim 1, wherein the offset indicates a timestamp within media content.

4. The device of claim 1, wherein the translation table maps file identifiers to memory locations across storage devices.

5. The device of claim 1, wherein the memory location comprises a physical memory address within the storage device.

6. The device of claim 1, wherein the processor is configured to shift the memory location by an amount based on the offset, the amount being determined based on a storage requirement per unit of time for media content.

7. The device of claim 1, wherein the processor is configured to use stored information indicating a size of the file to calculate the memory location modification.

8. The device of claim 1, wherein the processor is configured to read the data from a shifted memory location when the offset is present in the request.

9. The device of claim 1, wherein the processor is configured to identify the memory location for a starting point in the file using the offset.

10. A method comprising:
receiving, at an interface coupled to a bus, a request from a client device for a file, the request comprising a file identifier;
accessing a translation table stored in memory, the translation table configured to map the file identifier to a memory location corresponding to a storage device coupled to the bus;
extracting the file identifier from the request;
mapping the file identifier to a storage device and memory location using the translation table;
determining an offset in the request indicating a portion of the file;
modifying the memory location based on the offset; and
reading data from the memory location of the storage device via the interface.

11. The method of claim 10, further comprising transmitting the data to the client device, wherein transmitting the data comprises sending data messages to the client device.

12. The method of claim 10, wherein the offset indicates a timestamp within media content.

13. The method of claim 10, wherein the translation table maps file identifiers to memory locations across storage devices.

14. The method of claim 10, wherein the memory location comprises a physical memory address within the storage device.

15. The method of claim 10, wherein modifying the memory location comprises shifting the memory location by an amount based on the offset, the amount being determined based on a storage requirement per unit of time for media content.

16. The method of claim 10, further comprising using stored information indicating a size of the file to calculate the memory location modification.

17. The method of claim 10, wherein reading data comprises reading the data from a shifted memory location when the offset is present in the request.

18. A non-transitory computer-readable medium storing instructions that, when executed by a processor, cause the processor to:
receive a request from a client device for a file via an interface coupled to a bus, the request comprising a file identifier;
access a translation table stored in memory, the translation table configured to map the file identifier to a memory location corresponding to a storage device coupled to the bus;
extract the file identifier from the request;
map the file identifier to a storage device and memory location using the translation table;
determine an offset in the request indicating a portion of the file;
modify the memory location based on the offset; and
read data from the memory location of the storage device via the interface.

19. The non-transitory computer-readable medium of claim 18, wherein the instructions further cause the processor to transmit the data to the client device, and transmitting the data comprises sending data messages to the client device.

20. The non-transitory computer-readable medium of claim 18, wherein the offset indicates a timestamp within media content.
